(19) United States
(12) Patent Application Publication
(10) Pub. No.: US 2015/0289497 A1
(43) Pub. Date: Oct. 15, 2015

(54) AIRBORNE INSECT CONTROLLER

(71) Applicant: Eddie D. Bennett, Atlanta, GA (US)

(72) Inventor: Eddie D. Bennett, Atlanta, GA (US)

(21) Appl. No.: 14/683,315

(22) Filed: Apr. 10, 2015

Related U.S. Application Data
(60) Provisional application No. 61/977,867, filed on Apr. 10, 2014.

(51) Int. Cl. A01M 1/10; A01M 1/12; A01M 1/02

(52) U.S. Cl. CPC A01M 1/106; A01M 1/02; A01M 1/12

(57) ABSTRACT

An airborne insect controller with a base, a vertical port, and a housing is provided. The base is formed to rest on a surface and support the airborne insect controller in an upright position. The vertical support extends from the base in a vertical position relative to the base. The housing is attached to an end of the vertical support opposite the base so that the housing is suspended above the ground level. The housing has at least one opening leading into an internal portion of the housing. At least one shutter extends from a rim of the at least one opening to substantially cover the opening and form an entrance into the internal portion.

### CROSS-REFERENCE TO RELATED APPLICATION

This application claims the benefit of priority of U.S. provisional application No. 61/977,867, filed Apr. 10, 2014, the contents of which are herein incorporated by reference.

### BACKGROUND OF THE INVENTION

The present invention relates to insect control and, more particularly, to an airborne insect controller.

Currently, diseases are spread by airborne insects. Devices or systems that kill insects create airborne insect problems by attracting the insects to a premise, then spreading poor sanitary practices with the residue of the dead insects. Further, other devices are only used in a dark to minimum lighted environment. The other devices in the market practice poor sanitation, require an external power source, and attract flying insects to the inside of the premise.

As can be seen, there is a need for a device that controls airborne insects.

### SUMMARY OF THE INVENTION

In one aspect of the present invention,

In another aspect of the present invention,

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention shown with the base cap and the top lid removed;

FIG. 3 is a section detail view of the present invention along line 3-3 in FIG. 1; and

FIG. 4 is a section detail view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an airborne insect control system for reducing and eliminating any form of flying insects. The present invention prevents and/or eliminates the airborne insect's ability to transfer disease. The present invention is an improved sanitation method, reducing the airborne insect population. The system eliminates the problems of airborne disease carrying insects before entering they enter a premise.

In certain embodiments, the present invention provides an energy safe solution to airborne insect problems, using a free standing mechanical device, a green product, and good sanitation practices. Since the product is an outside airborne insect defense system, it works 24 hours, seven days a week, controlling the insects before they enter the premise. In certain embodiments sand or water may fill the base. Bait may be placed within the bait dispenser, and the top may be securely closed.

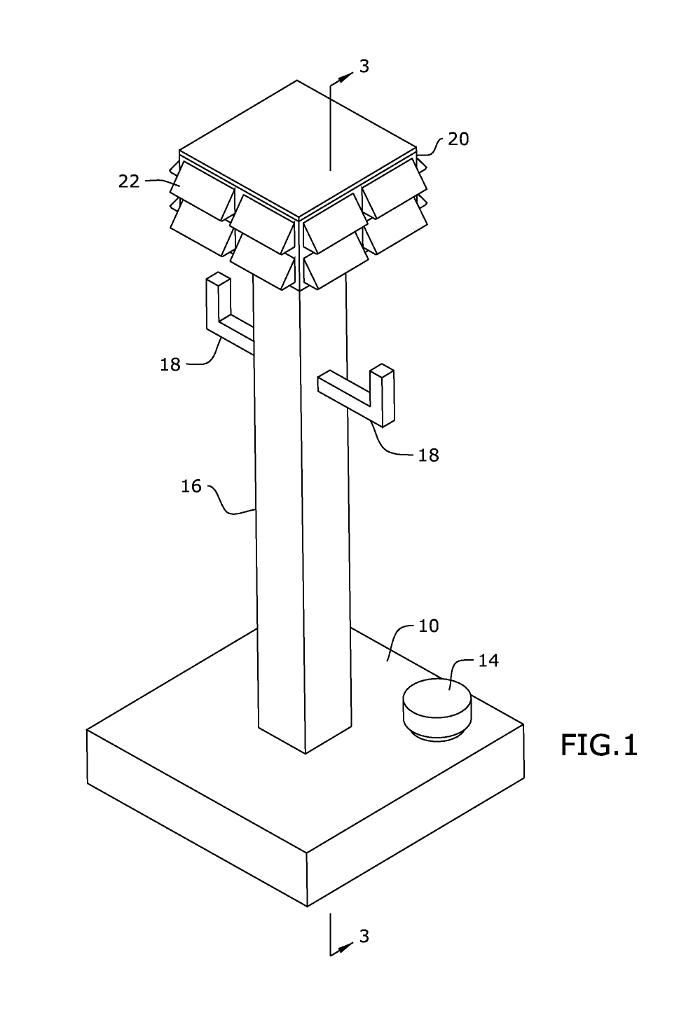

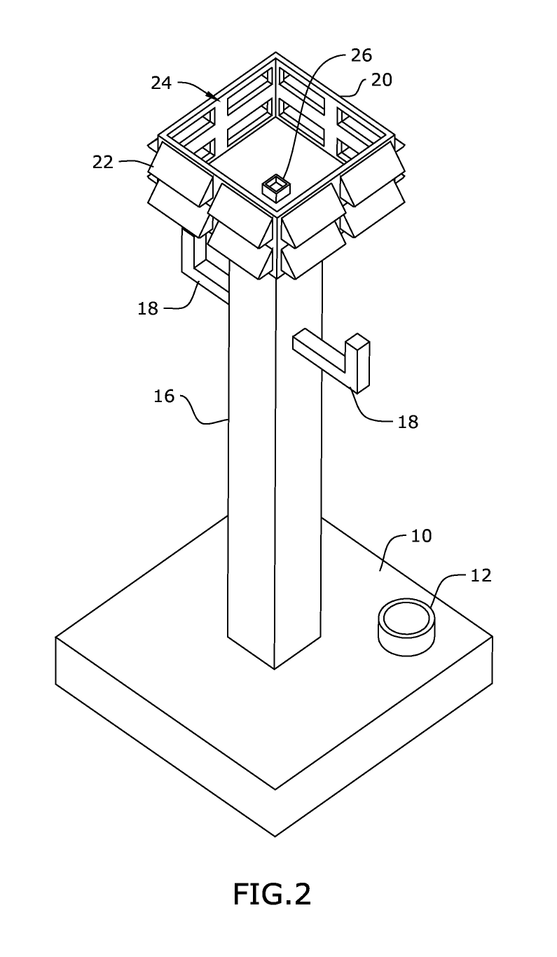

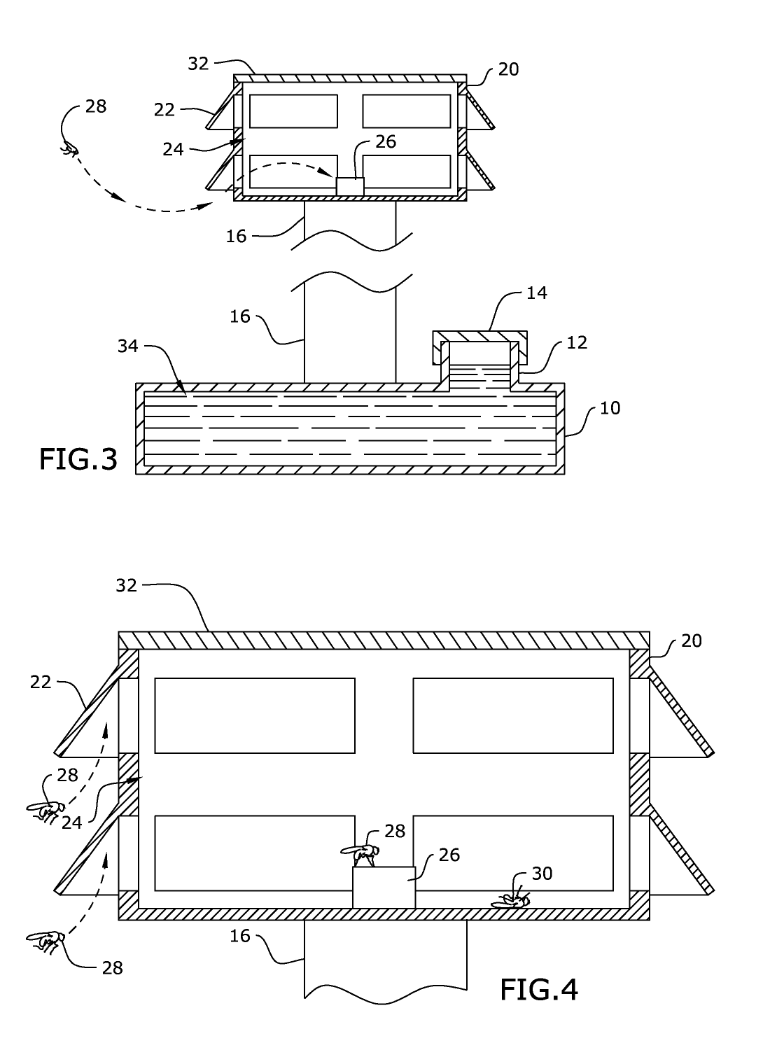

Referring to FIGS. 1 through 4, the present invention includes an airborne insect controller with a base 10, a vertical port 16, and a housing 20. The base 10 is formed to rest on a surface and support the airborne insect controller in an upright position. The vertical support 16 extends from the base 10 in a vertical position relative to the base 10. The housing 20 is attached to an end of the vertical support opposite the base 10 so that the housing 20 is suspended above the ground level. The housing 20 has at least one opening leading into an internal portion 24 of the housing 20. At least one shutter 22 extends from a rim of the at least one opening to substantially cover the opening and form an entrance into the internal portion 24.

The shutter 22 may cover the opening so that the entrance is substantially perpendicular to the opening. The perpendicular orientation makes it difficult for the insects 28 to escape the internal portion 24. In certain embodiments, the shutter 22 may extend from a top rim of the opening downwards at an angle away from the housing 20, forming the perpendicular entrance near the bottom of the opening. In certain embodiments, the present invention may include a plurality of openings on each side of the housing 20 to allow insects 28 to enter the housing 20 from all sides. Each of the openings may include a corresponding shutter 22.

To lure the insects 28 into the housing, bait may be secured within the internal portion 24. The bait may be poisonous to insects. In certain embodiments, the present invention may include a bait receptacle 26 within the internal portion 24. The bait receptacle 26 is formed to receive and secure insect bait within. In certain embodiments, the present invention may further include a top lid 32. The top lid 32 may be releasably attached to the top of the housing 20. The top lid 32 is removable from the housing 20 to access the internal portion 24 of the housing 20 to replace the bait as well as remove the dead insects 30.

The base 10 of the present invention may be weighted to suspend the airborne insect controller in the upright position and prevent the airborne insect controller from tipping over. However, the base 10 may also include apertures to receive spikes in order to further secure the base 10 to the ground. In certain embodiments, the base 10 may be substantially hollow. A cap 14 may be releasably secured to a fill port 12 leading into the hollow base 10. Sand or water 34 may be filled into the base 10 through the fill port 12 to provide additional weight.

The present invention may further include at least one hook 18 protruding from the vertical post 16. For example, the present invention may include a plurality of hooks 18, such as two hooks opposite of one another. The hooks 18 may be L-shaped hooks 18. Fly bags may be hung on the L shaped hooks for monitoring airborne insects.

The present invention may include the following dimensions. The base may be about 10 cm high and 47 cm wide with four sides. A filling cap is attached to the base. The vertical support may be a post about 104 cm height and 10 cm wide. The L-shaped hooks may be about 5 cm long and attached to either side of the post. The housing may be about 13 cm height and 25.5 cm wide on all four sides. Each side of the box may include four 3 cm openings with 2.5 cm shutters. The lid to cover the housing may be about 25.5 cm wide, and may open and close with adjustable hardware. The bait receptacle may be about 3 cm wide and 2 cm on all four sides. The above dimensions may be altered and are not limiting to the scope of the present invention.

In certain embodiments, the airborne insect defense system may be made completely of vinyl. In certain embodiments, the present invention may be made in different shapes and colors, may be about 104 cm tall, and the base is filled with water or sand. To make the present invention, assemble the post in the base, install the L shaped hooks on either side of the post, assemble the box, add the bait dispenser filled with pest material, and close the top lid securely.

The airborne insect defense system may be used to control, reduce, or monitor any airborne insect infestation or threats to the environment and public health. The system may provide complete monitoring and protection of the entire perimeter or outside of any structure. The present invention may control an existing problem regarding airborne insects or may prevent the problem from happening.

The elements of various pest controls are accomplished with the airborne insect defense system. The box may have a drawer installed to hold the bait dispenser. The box may have a locking device for protection and safety. The airborne insect defense system can be used in the Agriculture and Farming industry, to control or minimize the airborne insect carrying disease causing organisms.

It should be understood, of course, that the foregoing relates to exemplary embodiments of the invention and that modifications may be made without departing from the spirit and scope of the invention as set forth in the following claims.

What is claimed is:

1. An airborne insect controller comprising:
a base formed to rest on a surface and support the airborne insect controller in an upright position;
a vertical support extending from the base;
a housing attached to an end of the vertical support opposite the base; and
wherein the housing comprises at least one opening leading into an internal portion of the housing, and at least one shutter extending from a rim of the at least one opening to substantially cover the opening and forming an entrance into the internal portion.

2. The airborne insect controller of claim 1, wherein the entrance is substantially perpendicular to the opening.

3. The airborne insect controller of claim 1, wherein the shutter extends from a top rim of the opening downwards and at an angle away from the housing.

4. The airborne insect controller of claim 1, further comprising a bait receptacle within the housing, formed to receive and secure an insect bait within.

5. The airborne insect controller of claim 1, further comprising a plurality of openings, wherein each opening comprises a corresponding shutter.

6. The airborne insect controller of claim 1, further comprising a top lid releasably attached to the housing, wherein the top lid is removable to access the internal portion of the housing.

7. The airborne insect controller of claim 1, wherein the base is a weighted base.

8. The airborne insect controller of claim 1, wherein the base is substantially hollow to receive at least one of sand and water.

9. The airborne insect controller of claim 8, further comprising a cap releasably attached to a fill port leading into the hollow base.

10. The airborne insect controller of claim 1, further comprising at least one hook extending from the vertical support.

11. The airborne insect controller of claim 8, wherein the at least one hook is a plurality of hooks.

12. The airborne insect controller of claim 8, wherein the at least one hook is an L-shaped hook.
